(19) United States
(12) Patent Application Publication
(10) Pub. No.: US 2008/0003388 A1
(43) Pub. Date: Jan. 3, 2008

(54) Multilayer barrier container wall

(75) Inventor: James M. Fargher, Dataw Island, SC (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: Graham Packaging Company, L.P., York, PA (US)

(21) Appl. No.: 11/440,007

(22) Filed: May 25, 2006

(51) Int. Cl. B32B 27/08

(52) U.S. Cl. 428/35.7; 220/62.22

(57) ABSTRACT

A multilayer article of manufacture including a barrier layer and an oxygen scavenging layer is shown and described.

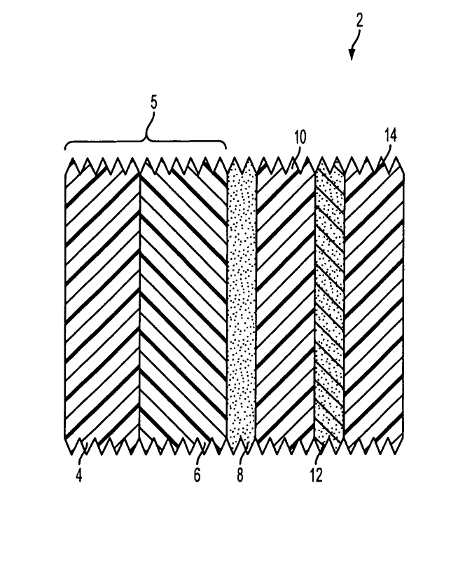

### FIELD OF THE INVENTION

The present invention pertains to a multilayer article of manufacture which includes a flavor and/or oxygen barrier and an oxygen scavenging layer. For example, the present invention includes a container which includes such a multilayer article of manufacture in a wall.

### BACKGROUND OF THE INVENTION

Plastic articles can have many desirable characteristics for packaging applications, including low cost, ease of and versatility in processing, and not shattering when dropped. Plastic articles can have a range of forms for packaging applications, including films, sheets, or containers, such as bottles. Plastic articles can be incorporated into packaging systems as, for example, walls, liners, or closures.

In certain applications, for example, packaging of perishable foods, a plastic article can be used to both contain an item and preserve the item. For example, imparting oxygen barrier properties to a plastic container can slow the penetration of oxygen through the container and thereby extend the shelf life of a perishable food within the container. Alternatively, imparting oxygen scavenging properties to a plastic container can allow oxygen to be removed from the interior of a container and thereby extend the shelf life of a perishable food within the container. Both oxygen barrier and oxygen scavenging properties can be imparted to a plastic container. See U.S. Pat. No. 5,759,653 to Collette et al., the contents of which are incorporated herein by reference in their entirety. The oxygen barrier can serve to extend the useful life of the oxygen scavenger by slowing the penetration of oxygen from the atmosphere to the oxygen scavenger. The oxygen scavenger can reduce the concentration of oxygen inside the container below what would be possible with an oxygen barrier alone, given that no oxygen barrier is perfect.

One way in which oxygen barrier and/or oxygen scavenging properties can be imparted to a plastic article is by forming a multilayer laminate. That is, a layer of material with oxygen barrier or oxygen scavenging properties can be sandwiched together with a layer of material with another property, for example, high mechanical strength.

It can be important to keep excess moisture, i.e., water, from permeating through a container wall and diluting or otherwise affecting the contents of a container. To achieve this a container can include a layer of a polymer which provides a barrier to moisture, such as a polyolefin, for example, polyethylene.

However, certain plastic materials, including polyolefins, can have the characteristic of “flavor scalping”, which is disadvantageous for certain food packaging applications. Flavor scalping refers to the characteristic of certain polymers to preferentially absorb certain constituents that impart a characteristic taste to foods, for example, orange juice. By preferentially absorbing certain constituents, a polyethylene container changes the concentration of constituents in the food in the container, which can result in a change of the taste of the food which a consumer may find undesirable. To prevent flavor scalping, a layer of material which acts as a barrier to constituents absorbed by a polymer forming the structure of a container can be interposed between the polymer forming the structure and the food in the container. See U.S. Pat. No. 4,977,004 to Bettle et al., the contents of which are incorporated herein by reference in their entirety.

There remains an unmet and ongoing need for a multilayer article of manufacture which includes a flavor barrier which protects a product from flavor scalping and an oxygen scavenger which protects a product from oxygen. There remains an unmet need for a multilayer article of manufacture which includes a moisture barrier which protects a product from moisture and an oxygen scavenger which protects a product from oxygen.

### SUMMARY OF THE INVENTION

It is therefore an object of the present invention to provide multilayer articles of manufacture which include a flavor barrier which protects a product from flavor scalping and an oxygen scavenger which protects a product from oxygen. It is an object of the present invention to provide multilayer articles of manufacture which include a moisture barrier which protects a product from moisture and an oxygen scavenger which protects a product from oxygen.

In an embodiment, a multilayer article of manufacture, includes a surface layer, and an oxygen scavenging layer. The surface layer can include a first barrier layer. The first barrier layer can include a flavor barrier and/or an oxygen barrier.

An embodiment in which a film, sheet, liner, container wall, or closure includes the multilayer article of manufacture.

In an embodiment, a container includes a multilayer sidewall defining an interior. The multilayer sidewall can include a first barrier layer adjacent to the interior and an oxygen scavenging layer. The first barrier layer can include a flavor barrier and/or an oxygen barrier.

### BRIEF DESCRIPTION OF THE DRAWINGS

The FIGURE is a cross-sectional side view of an embodiment of a multilayer article of manufacture according to the present invention.

### DETAILED DESCRIPTION

Embodiments of the invention are discussed in detail below. In describing embodiments, specific terminology is employed for the sake of clarity. However, the invention is not intended to be limited to the specific terminology so selected. A person skilled in the relevant art will recognize that other equivalent parts can be employed and other methods developed without parting from the spirit and scope of the invention. All references cited herein are incorporated by reference as if each had been individually incorporated.

The FIGURE presents a cross-sectional side view of an embodiment of a multilayer article of manufacture 2 according to the present invention. A surface layer of the multilayer article of manufacture 2 can include a first barrier layer 14. In applications of the multilayer article of manufacture 2 according to the present invention, where the article is used in contact with a food, the surface first barrier layer 14 can be used as the interior or food contact layer of the article. The first barrier layer 14 can include a flavor barrier and/or an oxygen barrier. As will be appreciated by those skilled in the art, some materials that act as flavor barriers can also act as oxygen barriers and vice versa. Nylons and ethylene-co-vinyl alcohol polymer (EVOH) are exemplary materials having both flavor and oxygen barrier properties. For example, the first barrier layer 14 can be located next to a product, such as a perishable food, to be protected from an external environment. Exemplary materials for the first barrier layer 14 can include, for example, a polyamide, amorphous nylon, nylon 6, EVOH, polyvinyl alcohol, poly(vinylidene chloride) (PVDC), poly(glycolic acid) (PGA), copolymers of these, alloys of these, blends of these, or laminates of these.

The first barrier layer 14 can act as a flavor barrier to minimize the preferential absorption of flavor or other desirable components from the contents of a container by other polymer materials included in the multilayer article of manufacture 2. In this manner, the multilayer article of manufacture 2 of the present invention can, for example, preserve the optimal flavor of a food. The first barrier layer 14 can also act as an oxygen barrier, to preserve the contents of a container of which the multilayer article of manufacture 2 forms a wall.

The multilayer article of manufacture 2 can include an oxygen scavenging layer 12. For example, the oxygen scavenging layer 12 can include an oxidizable polymer and a metal catalyst. As an example, the oxygen scavenging layer 12 can include an oxidizable organic polymer which scavenges oxygen and a transition metal in a positive oxidation state. For example, the oxygen scavenging layer 12 can include poly(m-xylylene adipamide) (MXD6) and cobalt. As another example, the oxygen scavenging layer 12 can include a polyester copolymer including polyolefin oligomer segments. Other exemplary oxygen scavenging material for use in the oxygen scavenging layer 12 are Amosorb®, manufactured by BP, and the OSP® system, manufactured by Chevron Phillips Chemical Company LLC (see http://www.cpchem.com/enu/osp.asp, http://www.cpchem.com/enu/osp_p_products.asp, http://www.cpchem.com/enu/osp_pg_processing.asp, and http://www.cpchem.com/enu/osp_tl_technical_library.asp, accessed Mar. 30, 2006).

These and other exemplary oxygen scavenging compositions are described in U.S. Pat. Nos. 6,083,585, 5,639,815, 5,885,481, and 5,744,056.

A multilayer article of manufacture 2 according to the present invention can include a structural layer 5 and can include a moisture barrier layer. The structural layer 5 can be sufficiently thick and rigid to provide mechanical strength to, for example, a container. The structural layer 5 can serve as the moisture barrier layer. For example, the structural layer 5 can include a polyolefin, such as polyethylene or polypropylene, which can act as a moisture barrier. The structural layer 5 can include, for example, a polyolefin, polystyrene, polycarbonate, polyethylene terephthalate, copolymers of these, alloys of these, blends of these, or laminates of these. In an exemplary embodiment, the structural layer 5 includes a layer of virgin polymer 4 and a layer of regrind polymer 6. Regrind polymer includes polymer material that is produced by a molder in a molding process and ground for re-use in a molding process by that same molder, for example, in combination with virgin polymer material. For example, flash and sprue from molding processes can be a source of regrind polymer. In an embodiment, the structural layer 5 includes a layer of virgin polymer 4 and a layer of recycled polymer material. The layer of recycled polymer material can include post-consumer recycled polymer material or a mixture of post-consumer recycled and regrind polymer material.

The multilayer article of manufacture 2 can include an oxygen scavenging layer 12 proximate to the first barrier layer 14. As used herein, two layers are proximate if the layers are separated only by a relatively thin layer of adhesive or other material or are in direct contact.

In an embodiment, the multilayer article of manufacture 2 includes a second barrier layer 10 proximate to the oxygen scavenging layer 12. The second barrier layer 10 can include a flavor barrier and/or an oxygen barrier. The second barrier layer 10 and the first barrier layer 14 can be formed of the same or can be formed of different materials. The second barrier layer 10 can include, for example, a polyamide, amorphous nylon, nylon 6, EVOH, polyvinyl alcohol, PVDC, PGA, copolymers of these, alloys of these, blends of these, or laminates of these.

An embodiment of the multilayer article of manufacture 2 includes the structural layer 5 proximate to the second barrier layer 10. The structural layer 5 can be in contact with the second barrier layer 10. Alternatively, the structural layer 5 can be in contact with an adhesive layer 8, and the adhesive layer 8 can be in contact with the second barrier layer 10; that is, the structural layer 5 and the second barrier layer 10 can have an adhesive layer 8 between them.

In an embodiment, the structural layer 5 includes a virgin polymer layer 4 proximate to a layer of regrind polymer 6. Thus, the virgin polymer layer 4 and the layer of regrind polymer 6 can be in contact with each other, or can have a layer of adhesive between them. The first barrier layer 14 can include polyamide, and the second barrier layer 10 can include polyamide. The layer of regrind polymer 6 can be proximate to the second barrier layer 10; the second barrier layer 10 can be in contact with the oxygen scavenging layer 12; and the oxygen scavenging layer 12 can be in contact with the first barrier layer 14.

In an embodiment, the virgin polymer layer 4 includes polyolefin and the layer of regrind polymer 6 includes polyolefin. The layer of regrind polymer 6 can be in contact with an adhesive layer 8, and the adhesive layer 8 can be in contact with the second barrier layer 10; that is, the adhesive layer 8 can be between the layer of regrind polymer 6 and the second barrier layer 10. The second barrier layer 10 can be in contact with the oxygen scavenging layer 12, and the oxygen scavenging layer 12 can be in contact with the first barrier layer 14.

In an embodiment, the structural layer 5 includes a virgin polymer layer 4 proximate to a layer of recycled polymer. The layer of recycled polymer can be proximate to the second barrier layer 10. In an embodiment, the virgin polymer layer 4 includes polyolefin and the layer of recycled polymer includes polyolefin. The layer of recycled polymer can be in contact with an adhesive layer 8, and the adhesive layer 8 can be in contact with the second barrier layer 10; that is, the adhesive layer 8 can be between the layer of recycled polymer and the second barrier layer 10.

In an exemplary method of making an article according to the present invention, the various layers are formed by extrusion. Barrier material issuing from an extruder can be split into two streams. The first stream can be directed to form a first barrier layer 14, and the second stream can be directed to form a second barrier layer 10. The streams can be directed so that a layer of oxygen scavenging material forming the oxygen scavenging layer 12 is inserted or extruded between the first barrier layer 14 and the second barrier layer 10. Additional layers, such as the structural layer 5 described above, can also be coextruded.

In an embodiment, the multilayer article of manufacture 2 has the form of a film, a sheet, a liner, a container wall, or a closure. For example, a container wall can be formed with the multilayer article of manufacture 2 to protect the contents of a container from oxygen and/or moisture. Alternatively, a liner can be formed with the multilayer article of manufacture 2; the liner can be inserted into a container, so that the liner protects the contents of the container from oxygen and/or moisture. A closure or a liner for a closure can be formed with the multilayer article of manufacture 2, so that the closure can prevent oxygen and/or moisture from entering a container through an opening and/or can remove oxygen from a container.

In an embodiment of the present invention, a container can include a multilayer sidewall defining an interior. The multilayer sidewall can include a first barrier layer 14 adjacent to the interior and an oxygen scavenging layer 12. The first barrier layer 14 can include a flavor barrier and/or an oxygen barrier. The sidewall can have a tubular form. The first barrier layer 14 can be proximate to the oxygen scavenging layer 12. The container can be, for example, a preform or a blow molded container.

By including a polyolefin structural layer 5, a second barrier layer 10 including an oxygen barrier, an oxygen scavenging layer 12, and a first barrier layer 14 including a flavor barrier in a multilayer article of manufacture 2, several desirable properties can be imparted to a container wall incorporating the multilayer article of manufacture 2. For example, the polyolefin structural layer 5 and the second barrier layer 10 of the container wall can protect the contents of a container from moisture and oxygen outside of the container. By slowing the influx of oxygen, the second barrier layer 10 can extend the useful life of the oxygen scavenging layer 12. The oxygen scavenging layer 12 can absorb residual oxygen from an interior of the container. And the first barrier layer 14 can prevent or slow the preferential absorption of certain components of the contents of the container by other layers of the container.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

What is claimed is:

1. A multilayer article of manufacture, comprising:
a surface layer comprising a first barrier layer; and
an oxygen scavenging layer,
wherein the first barrier layer comprises at least one of a flavor barrier and an oxygen barrier.

2. The multilayer article of manufacture of claim 1, wherein the oxygen scavenging layer is proximate to the first barrier layer.

3. The multilayer article of manufacture of claim 1, further comprising a second barrier layer proximate to the oxygen scavenging layer, wherein the second barrier layer comprises at least one of a flavor barrier and an oxygen barrier.

4. The multilayer article of manufacture of claim 1, wherein the first barrier layer is selected from the group consisting of polyamide, ethylene-co-vinyl alcohol polymer, polyvinyl alcohol, poly(vinylidene chloride), poly(glycolic acid), and copolymers, alloys, and blends thereof.

5. The multilayer article of manufacture of claim 1, wherein the first barrier layer comprises amorphous nylon or nylon 6.

6. The multilayer article of manufacture of claim 1, wherein the oxygen scavenging layer comprises an oxidizable polymer and a metal catalyst.

7. The multilayer article of manufacture of claim 1, wherein the oxygen scavenging layer comprises MXD6 and cobalt or comprises Amosorb®.

8. The multilayer article of manufacture of claim 1, further comprising a moisture barrier layer.

9. The multilayer article of manufacture of claim 1, further comprising a structural layer.

10. The multilayer article of manufacture of claim 9, wherein the structural layer comprises a polyolefin.

11. The multilayer article of manufacture of claim 10, wherein the structural layer comprises polyethylene.

12. The multilayer article of manufacture of claim 10, wherein the structural layer comprises polypropylene.

13. The multilayer article of manufacture of claim 9, wherein the structural layer comprises a layer of virgin polymer and a layer of regrind polymer or recycled polymer.

14. The multilayer article of manufacture of claim 3, wherein the second barrier layer is selected from the group consisting of polyamide, ethylene-co-vinyl alcohol polymer, polyvinyl alcohol, poly(vinylidene chloride), poly(glycolic acid), and copolymers, alloys, and blends thereof.

15. The multilayer article of manufacture of claim 3, wherein the second barrier layer is amorphous nylon or nylon 6.

16. The multilayer article of manufacture of claim 3, further comprising a structural layer, wherein the structural layer is proximate to the second barrier layer.

17. The multilayer article of manufacture of claim 16, further comprising an adhesive layer, wherein the structural layer is in contact with the adhesive layer, and the adhesive layer is in contact with the second barrier layer.

18. The multilayer article of manufacture of claim 16, wherein the oxygen scavenging layer is proximate to the first barrier layer.

19. The multilayer article of manufacture of claim 18, further comprising an adhesive layer, wherein the adhesive layer is between the structural layer and the second barrier layer.

20. The multilayer article of manufacture of claim 18,
wherein the structural layer comprises a virgin polymer layer in contact with a layer of regrind polymer or recycled polymer,
wherein the first barrier layer comprises a polyamide,
wherein the second barrier layer comprises a polyamide,
wherein the layer of regrind polymer or recycled polymer is proximate to the second barrier layer,
wherein the second barrier layer is in contact with the oxygen scavenging layer, and
wherein the oxygen scavenging layer is in contact with the first barrier layer.

21. The multilayer article of manufacture of claim 18:
further comprising an adhesive layer,
wherein the structural layer comprises a virgin polymer layer comprising polyolefin in contact with a layer of regrind polymer comprising polyolefin or recycled polymer comprising polyolefin,
wherein the second barrier layer comprises a polyamide,
wherein the oxygen scavenging layer comprises MXD6 and cobalt,
wherein the first barrier layer comprises a polyamide,
wherein the layer of regrind polymer or recycled polymer is in contact with the adhesive layer,
wherein the adhesive layer is in contact with the second barrier layer,
wherein the second barrier layer is in contact with the oxygen scavenging layer, and
wherein the oxygen scavenging layer is in contact with the first barrier layer.

22. A film, sheet, liner, container wall, or closure comprising the multilayer article of manufacture of claim 1.

23. A container comprising a multilayer sidewall defining an interior:
the multilayer sidewall comprising
a first barrier layer adjacent to the interior and
an oxygen scavenging layer,
wherein the first barrier layer comprises at least one of a flavor barrier and an oxygen barrier.

24. The container of claim 23, wherein the multilayer sidewall has a tubular form.

25. The container of claim 23, wherein the first barrier layer is proximate to the oxygen scavenging layer.

26. The container of claim 23 being a preform or a blow molded container.
